(19) United States
(12) Patent Application Publication
(10) Pub. No.: US 2024/0160530 A1
(43) Pub. Date: May 16, 2024

(54) SECURING SENSITIVE DEBUG DATA

(71) Applicant: International Business Machines Corporation, Armonk, NY (US)

(72) Inventors: Raja Das, Bengaluru (IN); Sandeep Korrapati, BANGALORE (IN); Akhilesh S, BANGALORE (IN)

(73) Assignee: International Business Machines Corporation, Armonk, NY (US)

(21) Appl. No.: 17/988,268

(22) Filed: Nov. 16, 2022

(51) Int. Cl. G06F 11/14; G06F 11/07; G06F 11/36

(52) U.S. Cl. CPC G06F 11/1441; G06F 11/0778; G06F 11/3644

(57) ABSTRACT

An embodiment monitors an operational state of a processor-based system and identifies a system error that satisfies a reboot condition for a reboot event. The embodiment generates debug data indicative of the operational state of the system when the system error occurred. The embodiment stores the debug data in a memory that retains data during the reboot event. The embodiment intercepts a debug data requests from an untrusted entity, thereby preventing the untrusted entity from directly accessing the debug data in the memory. The embodiment analyzes the debug data using a sensitive data detection process where the analyzing detects sensitive data in the debug data. The embodiment generates modified debug data by performing a data protection process on the debug data and then sends, as a response to the debug data requests, the modified debug data to the untrusted entity.

### BACKGROUND

The present invention relates generally to computer system security. More particularly, the present invention relates to a method, system, and computer program for securing sensitive debug data.

Various processor-based systems, such as servers, computers, smartphones, and Internet of Things (IoT) devices, continue to become more commonplace and their continued operation is increasingly relied upon for various business and personal tasks. In some cases, such systems provide critical services, such as for health care, finance, and public utility applications that are subject to regulatory reliability requirements. When a failure occurs during operation of such systems, it may be important to immediately collect information about the failure for debugging purposes to prevent a recurrence of the failure.

An example of a failure that may occur in such systems is a kernel failure, sometimes referred to as a kernel panic. The kernel panic is an action taken by an operating system (OS) upon detection of a kernel error from which the system cannot safely recover without restarting. Upon detection of the kernel panic, the system may output an error message to a display device and perform a memory dump of debug data. The debug data typically includes contents of the system's memory at the moment when the failure occurred. The debug data may be collected by engineers or vendors for troubleshooting and analysis to determine the cause of the failure.

### SUMMARY

The illustrative embodiments provide for securing sensitive debug data. An embodiment includes monitoring, by an exception handler, an operational state of a processor-based system. The monitoring comprises identifying a system error that satisfies a reboot condition. The system schedules a reboot event responsive to satisfaction of the reboot condition. The embodiment also includes generating debug data indicative of the operational state of the system when the system error occurred. The embodiment also includes storing the debug data in a memory that retains data during the reboot event. The embodiment also includes intercepting a debug data request from an untrusted entity, thereby preventing the untrusted entity from directly accessing the debug data in the memory. The embodiment also includes analyzing the debug data using a sensitive data detection process, where the analyzing detects sensitive data in the debug data. The embodiment also includes generating modified debug data by performing a data protection process on the debug data. The embodiment also includes sending, as a response to the debug data request, the modified debug data to the untrusted entity. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a functional block diagram of an exemplary processor-based system in accordance with an illustrative embodiment;

FIG. 3 depicts a functional block diagram of an exemplary processor-based system in accordance with an illustrative embodiment;

FIG. 4 depicts a functional block diagram of reboot subprocesses in accordance with an illustrative embodiment;

FIG. 5 depicts a functional block diagram of a reboot subprocess in accordance with an illustrative embodiment;

FIG. 6 depicts a functional block diagram of a data protection process in accordance with an illustrative embodiment;

FIG. 7 depicts a functional block diagram of a data protection process in accordance with an illustrative embodiment;

FIG. 8 depicts a functional block diagram of a data protection process in accordance with an illustrative embodiment;

FIG. 9 depicts a block diagram of an example secure debugging module in accordance with an illustrative embodiment; and

FIG. 10 depicts a flowchart of an example process for securing sensitive debug data in accordance with an illustrative embodiment.

### DETAILED DESCRIPTION

In a secure boot enabled system, a root of trust entity is a core element of the system's security. The root of trust entity serves as a foundation upon which trust is extended in layers to code loaded and executed later using cryptographic techniques such as digital code signing. Because the root of trust entity has such a critical role, access to the root of trust entity is typically very strictly limited. For example, typical security measures discourage and block any out of band accesses to the root of trust entity.

While such strict security policies are desirable for preventing unauthorized access to the root of trust entity, they are equally effective for preventing access for debugging the secure root of trust entity. While a developer would prefer to have access to the memory and hardware state of the entity in a failure state, from a security perspective, providing such access creates a new potential attack vector for entities seeking unauthorized access.

A Core Root of Trust for Measurement (CRTM) is an example of a root of trust entity that is used on systems having a Trusted Platform Module (TPM). The CRTM is typically a first piece of BIOS (Basic Input/Output System) code that executes on a main processor during a boot process. On a system with a TPM, the CRTM is implicitly trusted to bootstrap the process of building a measurement chain for subsequent attestation of other firmware and software that is executed on the computer system.

Depending on a state of system at a point of failure, the data contained in facilities required to debug CRTM may contain sensitive data. For example, a system failure stemming from a halt in CRTM firmware may occur during an encryption process. In such an example, the encryption key may be present in a general-purpose register (GPR) or Special Purpose Register (SPR) used by the CRTM. The encryption key is an example of sensitive data that the system would ordinarily store in protected memory to prevent it from being leaked to untrusted entities or unauthorized users. However, the encryption key may be intermingled with other data that a developer would prefer to access for use as debug data because the data may help explain the system failure.

The illustrative embodiments generally address and solve the above-described problems and other problems related to such debugging constraints in a secure system by providing a process that securely extracts debug data and protects sensitive information that may be included in the debug data. Disclosed embodiments monitor status data indicative of an operational state of a processor-based system and identify status data associated with a system error. The system error is evaluated to determine if a reboot will be required in order to recover from the error (i.e., the error satisfies a reboot condition). If a reboot condition is detected, the embodiment generates debug data indicative of a state of the system when the system error occurred, for example based on processor registers, cache, logs, etc.

A reboot as referred to herein may be any process by which a processor-based system is restarted, intentionally or unintentionally. Unless otherwise specified, a reboot as referred to herein may include processes involving complete removal of power to the system, including processes commonly referred to as a cold reboot or a hard reboot (referred to herein as a cold reboot), and may include processes not involving complete removal of power to the system, including processes commonly referred to as a warm reboot or a soft reboot (referred to herein as a warm reboot).

The embodiment stores the debug data in a protected memory. A protected memory refers to memory of a computer readable storage medium that is protected, either at the hardware or the software level, from read and/or write access without permission. After the reboot, the embodiment responds to a request for debug data from an untrusted entity by performing a data protection process on the debug data to remove or encrypt sensitive data in the debug data before sending the debug data to the untrusted entity. An untrusted entity refers to an entity that is not trusted from a system's perspective due to a lack of a connection to the system's trust chain.

An embodiment can be implemented as a software application. The application implementing an embodiment can be configured as a modification in an existing manufacturing system, as a separate application that operates in conjunction with an existing manufacturing system, as a standalone system, or some combination thereof.

An embodiment monitors system state data for an indication of a system failure that causes the system kernel to go into a halt state. The state data may vary depending on the type of system (e.g., operating system and hardware), but in general may include system error messages, error codes, log entries, or other data representative of a system error. The system error may also vary depending on the type of system, but in general may include kernel errors, kernel panics, stop errors, or the like that cause partial or complete loss of kernel functionality.

A system failure that causes partial or complete loss of kernel functionality is generally recognized by the system as a condition that requires a reboot of the system for recovery. The loss of kernel functionality typically requires a reboot to recover in most types of systems. Such errors are therefore examples of errors that satisfy a reboot condition.

In illustrative embodiments, when a system error is detected that satisfies a reboot condition (e.g., a system error that causes loss of kernel functionality), debug data is temporarily saved into a protected section of memory. Since at least a portion of kernel functionality will have been lost at this point, the embodiment includes generating and saving a copy of the debug data without the assistance of the kernel. For example, in some embodiments, an exception handler generates and saves the copy of the debug data. The debug data may vary depending on the type of system (e.g., operating system and hardware), but in general may include data from processor memories (e.g., registers and cache), logs, and/or trace arrays.

Since the kernel is in a halted state while the debug data is being generated, this means that kernel functionality for processing the debug data is not available. As a result, the kernel is not available at this time to filter sensitive information from the debug data. For this reason, the debug data is stored in the protected section of memory where it can be retained during a reboot and processed thereafter.

After the reboot has occurred, a debugging device that is an untrusted device to the recovered system connects via an I/O port using a trusted protocol. The untrusted device issues a request for debug data that will be used to try to determine the reason for the system failure. Since the debug data is stored in protected memory, the untrusted device is not able to directly access the debug data. Instead, the untrusted entity must request the debug data from a secure debugging module.

In the illustrated embodiment, the secure debugging module receives the request for debug data. Responsive to the request, the secure debugging module uses a data sanitization module to analyze the debug data using a sensitive data detection/sanitization process that detects and removes sensitive data in the debug data.

In some embodiments, the data sanitization module detects sensitive data according to an audit policy. An audit policy is a set of preferences, rules and/or criteria that protect sensitive data in the debug data. For example, an audit policy may define “sensitive objects” as files or objects that contain particular keywords (e.g., “confidential,” or “privileged”) and/or are associated with particular keywords (e.g., in metadata) or particular flags (e.g., in metadata identifying a document or email as personal, confidential, etc.). An audit policy may further specify rules for handling sensitive objects. As an example, an audit policy may require that a reviewer approve the transfer of any potentially sensitive objects from the protected memory to the untrusted entity. Thus, in some embodiments, the data protection process includes one or more protective measures in the form of data sanitization to prevent sensitive data from being leaked with debug data sent to the untrusted entity.

In the illustrated embodiment, the window module detects whether sensitive data was being processed during a window of time in which the system error occurred, for example by reviewing system logs. For example, in some embodiments, the window module reviews the system logs using an audit policy that includes a set of preferences, rules and/or criteria that the window module uses to identify sensitive data in the debug data. For example, an audit policy may define “sensitive objects” as files or objects that contain particular keywords (e.g., “confidential,” or “privileged”) and/or are associated with particular keywords (e.g., in metadata) or particular flags (e.g., in metadata identifying a document or email as personal, confidential, etc.). An audit policy may further specify rules for handling sensitive objects. As an example, an audit policy may require that a reviewer approve the transfer of any potentially sensitive objects from the protected memory to the untrusted entity. Thus, in some embodiments, the data protection process includes one or more protective measures in the form of a time-window analysis to prevent sensitive data from being leaked with debug data sent to the untrusted entity.

In some embodiments, the data sanitization module detects sensitive data according to an audit policy. An audit policy is a set of preferences, rules and/or criteria that protect sensitive data in the debug data. For example, an audit policy may define “sensitive objects” as files or objects that contain particular keywords (e.g., “confidential,” or “privileged”) and/or are associated with particular keywords (e.g., in metadata) or particular flags (e.g., in metadata identifying a document or email as personal, confidential, etc.). An audit policy may further specify rules for handling sensitive objects. As an example, an audit policy may require that a reviewer approve the transfer of any potentially sensitive objects from the protected memory to the untrusted entity. Thus, in some embodiments, the data protection process includes one or more protective measures in the form of data encryption to prevent sensitive data from being leaked with debug data sent to the untrusted entity.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

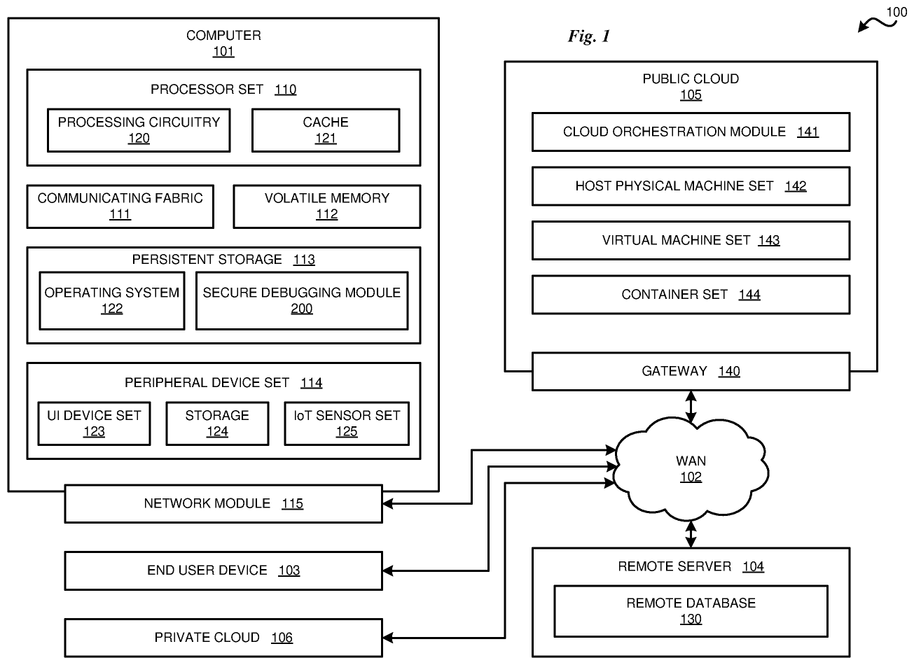

With reference to FIG. 1, this figure depicts a block diagram of a computing environment 100. Computing environment 100 contains an example of an environment for the execution of at least some of the computer code involved in performing the inventive methods, such as an improved secure debugging module 200 that prevents sensitive data from being leaked with debugging data. In addition to secure debugging module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and secure debugging module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in secure debugging module 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in secure debugging module 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

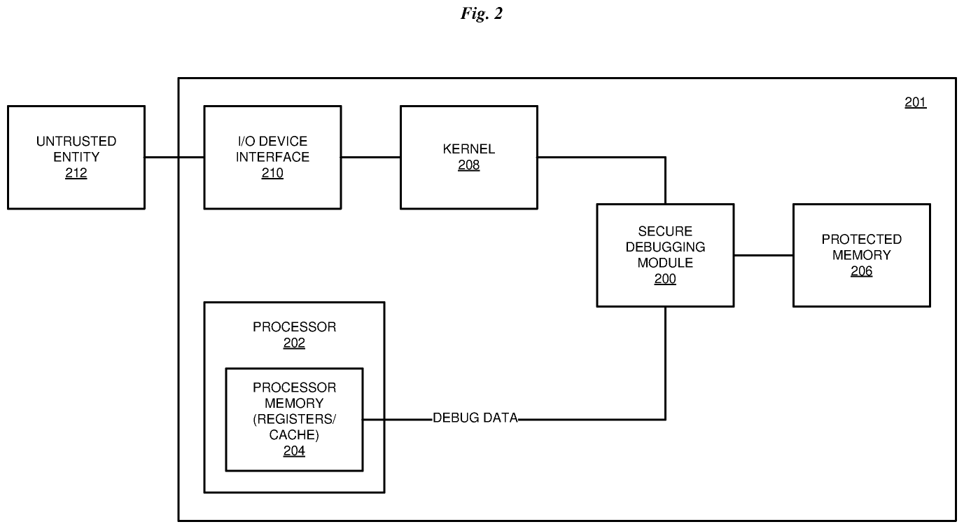

With reference to FIG. 2, this figure depicts a functional block diagram of an exemplary processor-based system 201 in accordance with an illustrative embodiment. In the illustrated embodiment, the processor-based system 201 includes a secure debugging module 200 of FIG. 1.

In the illustrated embodiment, the processor-based system 201 also includes a processor 202, a protected memory 206, a kernel 208, and a I/O device interface 210. The processor 202 includes processor memory (registers/cache) 204. The I/O device interface 210 provides an interface for allowing the system 201 to communicate with an untrusted entity 212. In alternative embodiments, the processor-based system 201 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

It will be appreciated that the view of the processor-based system 201 in FIG. 2 is a simplified block diagram not intended to show every aspect of the processor-based system 201. Rather, in actual implementations, the system 201 may have many additional components not shown, such as a display, a user input device, a network interface adapter, etc. In some embodiments, the processor 202 is an example of the processor set 110 of FIG. 1, with the processor memory (registers/cache) 204 being an example of the processing circuitry 120 and cache 121 of FIG. 1.

In the illustrated embodiment, the secure debugging module 200 uses the protected memory 206 to store debug data during and after a system reboot caused by a system error. The protected memory 206 may be any computer readable storage medium that is not directly accessible to the untrusted entity 212. In some embodiments, the protected memory 206 may also be part of the processor memory (registers/cache) 204. In some embodiments, the protected memory 206 is protected at a hardware level, so within the hardware itself it is hard coded such that that the protected memory 206 is only accessible by certain code sections, for example only accessible to the secure debugging module 200.

In the illustrated embodiment, the untrusted entity 212 may be a debugging device that is not part of the chain of trust of the system 201. Thus, it is not authorized to directly access the protected memory 206. Instead, the untrusted entity 212 must request the debug data from the secure debugging module 200 via the I/O device interface 210. In some embodiments, the I/O device interface 210 permits communication with an untrusted entity 212 such as an external debugging device via a trusted protocol. For example, in some embodiments the I/O device interface 210 comprises a baseboard management controller (BMC), Joint Test Action Group (JTAG), or I²C interface that is coupled to the untrusted entity 212.

In the illustrated embodiment, the I/O device interface 210 relays this request for debug data to the I/O device interface 210. If the reboot has occurred since the system failure associated with the debug data, then the kernel 208 is fully functional. Thus, the secure debugging module 200 may use kernel 208 functionality for analyzing the debug data using a sensitive data detection process that detects sensitive data in the debug data.

In some embodiments, the data protection process includes one or more protective measures to prevent sensitive data from being leaked with debug data sent to the untrusted entity 212. For example, in some embodiments, the kernel 208 sanitizes the debug data by removing the sensitive data from the debug data.

Alternatively, kernel 208 detects whether sensitive data was being processed during a window of time in which the system error occurred, for example by reviewing system logs. In some embodiments, if no sensitive data was being processed, then the debug data can be sent to the untrusted entity 212. If sensitive data was being processed, then the debug data is not sent, or alternatively, the kernel 208 sanitizes the debug data by removing the sensitive data before sending the debug data to the untrusted entity 212.

As yet another alternative, the kernel may encrypt some or all of the debug data before sending it to the untrusted entity 212. Then, once the encrypted data is in possession of the untrusted entity 212, if the user of the untrusted entity 212 is authorized to access the encrypted data, the untrusted entity 212 will be in possession of the necessary keys to decrypt it.

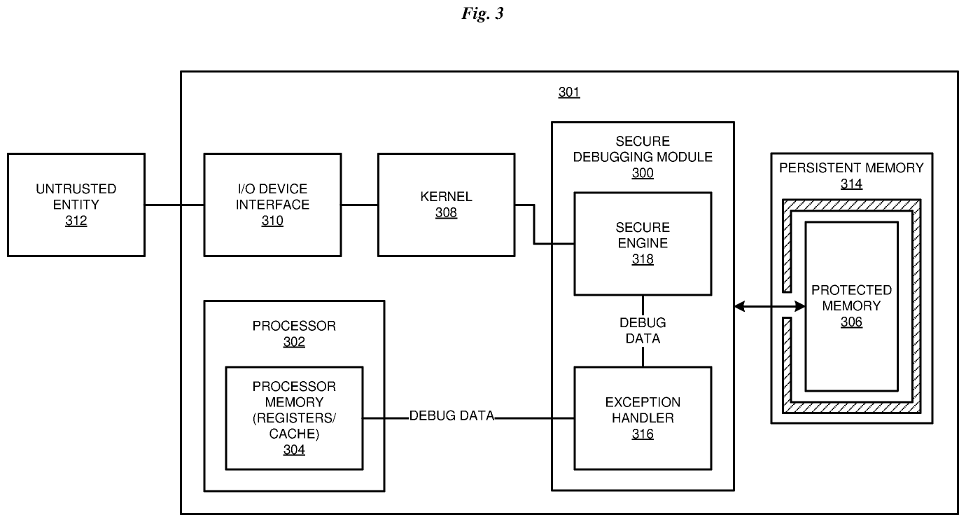

With reference to FIG. 3, this figure depicts a functional block diagram of an exemplary processor-based system 301 in accordance with an illustrative embodiment. In the illustrated embodiment, the processor-based system 301 includes a secure debugging module 300. In some embodiments, the secure debugging module 300 is an example of the secure debugging module 200 of FIGS. 1 and 2.

In the illustrated embodiment, the processor-based system 301 also includes a processor 302, a protected memory 306, a kernel 308, and a I/O device interface 310. The processor 302 includes processor memory (registers/cache) 304. The I/O device interface 310 provides an interface for allowing the system 301 to communicate with an untrusted entity 312. In alternative embodiments, the processor-based system 301 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

It will be appreciated that the view of the processor-based system 301 in FIG. 3 is a simplified block diagram not intended to show every aspect of the processor-based system 301. Rather, in actual implementations, the system 301 may have many additional components not shown, such as a display, a user input device, a network interface adapter, etc. In some embodiments, the processor 302 is an example of the processor set 110 of FIG. 1, with the processor memory (registers/cache) 304 being an example of the processing circuitry 120 and cache 121 of FIG. 1.

In the illustrated embodiment, the secure debugging module 300 includes an exception handler 316 and a secure engine 318. In some embodiments, the secure engine 318 handles a secure boot for the system 301 and interactions with untrusted entities coming into the system 301. In some embodiments, the secure engine 318 is a trusted entity that establishes the core root of trust for the system 301.

In some embodiments, if the secure engine 318 fails or halts full operation, any external communication is lost temporarily because the secure engine 318 is no longer responding. For example, in some embodiments there are some exceptions that cause the secure engine 318 to stop responding to requests. In some such embodiments, the system 301 can be reset to restore full operation to the secure engine 318. However, in order to determine the reason for the failure, it is desirable to get relevant debug data. For example, in some embodiments, the secure engine 318 is a stand-alone device from which the exception handler 316 can retrieve the debug data. In some embodiments, the secure engine 318 shares a chip with the processor 302 and uses the processor memory (registers/cache) 304.

Thus, in such embodiments, the exception handler 316 detects the exception that caused the failure. The exception handler 316 generates debug data indicative of a state of the system as the system error occurred and stores the debug data in protected memory 306, which is part of a persistent memory 314 that retains data during the reboot event.

Thus, the exception handler 316 uses the protected memory 306 to store debug data during and after a system reboot caused by a system error. The protected memory 306 may be any computer readable storage medium that is not directly accessible to the untrusted entity 312. In some embodiments, the protected memory 306 may also be part of the processor memory (registers/cache) 304. In some embodiments, the protected memory 306 is protected at a hardware level, so within the hardware itself it is hard coded such that that the protected memory 306 is only accessible by certain code sections, for example only accessible to the secure debugging module 300.

In the illustrated embodiment, the untrusted entity 312 may be a debugging device that is not part of the chain of trust of the system 301. Thus, it is not authorized to directly access the protected memory 306. Instead, the untrusted entity 312 must request the debug data from the secure debugging module 300 via the I/O device interface 310. In some embodiments, the I/O device interface 310 permits communication with an untrusted entity 312 such as an external debugging device via a trusted protocol. For example, in some embodiments the I/O device interface 310 comprises a baseboard management controller (BMC), Joint Test Action Group (JTAG), or I²C interface that is coupled to the untrusted entity 312.

In the illustrated embodiment, the I/O device interface 310 relays this request for debug data to the I/O device interface 310. If the reboot has occurred since the system failure associated with the debug data, then the kernel 308 is fully functional. Thus, the secure debugging module 300 may use kernel 308 functionality for analyzing the debug data using a sensitive data detection process that detects sensitive data in the debug data.

In some embodiments, the data protection process includes one or more protective measures to prevent sensitive data from being leaked with debug data sent to the untrusted entity 312. For example, in some embodiments, the kernel 308 sanitizes the debug data by removing the sensitive data from the debug data.

Alternatively, kernel 308 detects whether sensitive data was being processed during a window of time in which the system error occurred, for example by reviewing system logs. In some embodiments, if no sensitive data was being processed, then the debug data can be sent to the untrusted entity 312. If sensitive data was being processed, then the debug data is not sent, or alternatively, the kernel 308 sanitizes the debug data by removing the sensitive data before sending the debug data to the untrusted entity 312.

As yet another alternative, the kernel may call the secure engine 318 to encrypt some or all of the debug data before sending it to the untrusted entity 312. Then, once the encrypted data is in possession of the untrusted entity 312, if the user of the untrusted entity 312 is authorized to access the encrypted data, the untrusted entity 312 will be in possession of the necessary keys to decrypt it.

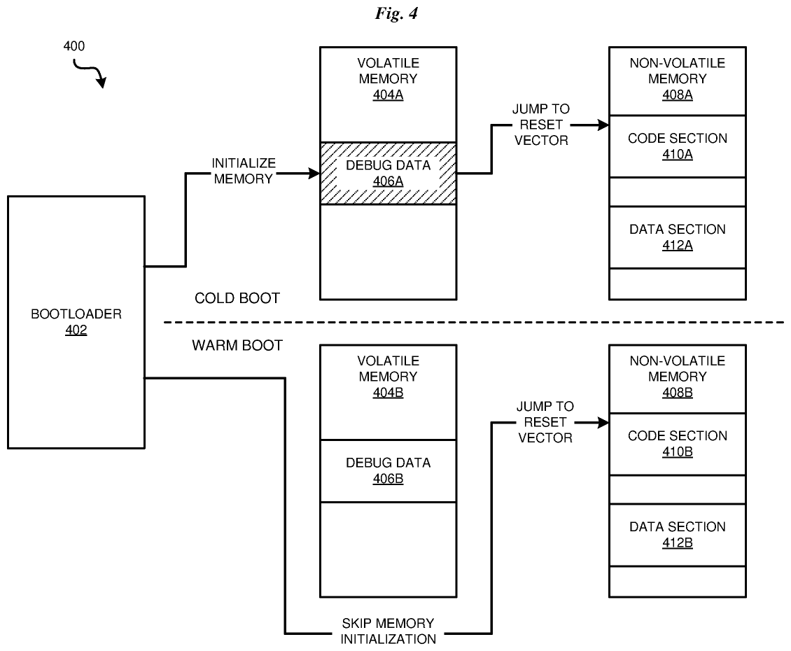

With reference to FIG. 4, this figure depicts a functional block diagram 400 of reboot subprocesses in accordance with an illustrative embodiment. In the illustrated embodiment, a processor-based system can perform two different types of reboots: a cold reboot and a warm reboot. A cold reboot involves complete removal of power to the system, whereas the power remains on, or at least a portion of the power remains on, for a warm reboot.

In the illustrated embodiment, a bootloader 402 initiates either a cold reboot or a warm reboot. For a cold reboot, volatile memory 404A is initialized and then the instructions jump to the reset vector at the beginning of the code section 410A in a non-volatile memory 408A that also stores a data section 412A. In a scenario in which the debug data 406A needed to troubleshoot a system failure is in volatile memory 404A, the initialization process will cause the debug data 406A to be lost after a cold reboot. Thus, in such systems a warm reboot is preferred if the non-volatile memory 408B is storing the debug data 406B because the warm reboot skips the initialization of the volatile memory 404B and goes straight to the reset vector at the beginning of the code section 410B in a non-volatile memory 408B that also stores a data section 412B.

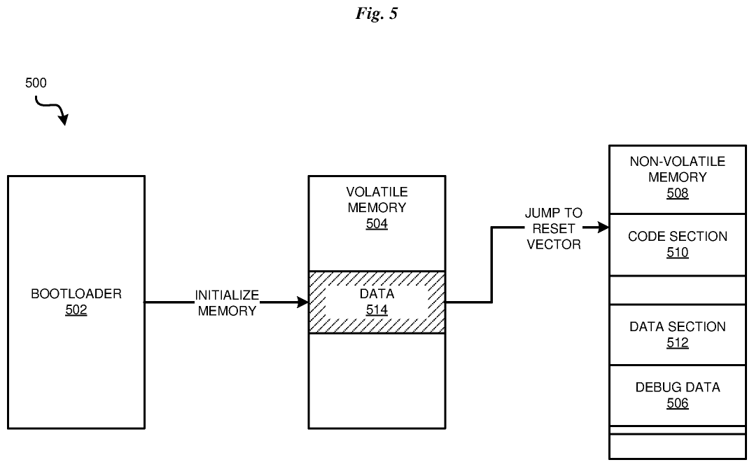

With reference to FIG. 5, this figure depicts a functional block diagram 500 of a reboot subprocess in accordance with an illustrative embodiment. In contrast with FIG. 4, in the illustrated embodiment of FIG. 5, a processor-based system can only perform one type of reboot, which is similar or the same as the cold reboot of FIG. 5.

Thus, in the illustrated embodiment, a bootloader 502 initiates a reboot. For the reboot, volatile memory 504 is initialized, causing data 514 to be erased. The bootloader then proceeds to jump to the reset vector at the beginning of the code section 510 in a non-volatile memory 508 that also stores a data section 512. In such embodiments, the debug data 506 needed to troubleshoot a system failure is in non-volatile memory 508.

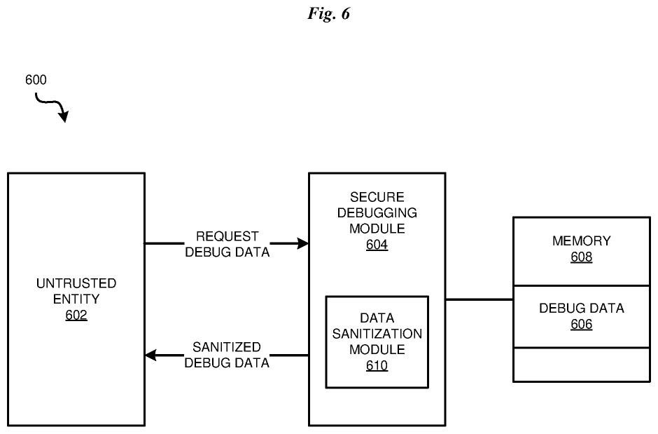

As described above in connection with FIGS. 2 and 3, in some embodiments, an untrusted entity may be a debugging device that requests debug data from a secure debugging module via an I/O device interface after a system error and warm reboot. FIGS. 6-8 illustrate examples of data protection processes that allow for providing the debug data in response to the request from the untrusted entity without leaking sensitive data.

With reference to FIG. 6, this figure depicts a functional block diagram of a data protection process 600 in accordance with an illustrative embodiment. In the illustrated embodiment, a secure debugging module 604 is an example of the secure debugging module 200 of FIGS. 1-2 or the secure debugging module 300 of FIG. 3. Also, in the illustrated embodiment, the secure debugging module 604 performs the data protection process 600, whereas in alternative embodiments, some or all of the data protection process 600 may be performed by one or more alternative devices or modules.

In the illustrated embodiment, the memory 608 is protected memory. The untrusted entity 602 may be a debugging device that is not part of the chain of trust of the host system for the secure debugging module 604 and the memory 608. Thus, the untrusted entity 602 is not authorized to directly access the debug data 606 in the protected memory 608. Instead, the untrusted entity 602 must request the debug data from the secure debugging module 604.

In the illustrated embodiment, the secure debugging module 604 receives the request for debug data. Responsive to the request, the secure debugging module 604 uses a data sanitization module 610 to analyze the debug data using a sensitive data detection/sanitization process that detects and removes sensitive data in the debug data. In some embodiments, the data sanitization module 610 may be part of a kernel (e.g., kernel 208 of FIG. 2).

In some embodiments, the data sanitization module 610 detects sensitive data according to an audit policy. An audit policy is a set of preferences, rules and/or criteria that protect sensitive data in the debug data. For example, an audit policy may define “sensitive objects” as files or objects that contain particular keywords (e.g., “confidential,” or “privileged”) and/or are associated with particular keywords (e.g., in metadata) or particular flags (e.g., in metadata identifying a document or email as personal, confidential, etc.). An audit policy may further specify rules for handling sensitive objects. As an example, an audit policy may require that a reviewer approve the transfer of any potentially sensitive objects from the protected memory to the untrusted entity 602.

Thus, in some embodiments, the data protection process includes one or more protective measures in the form of data sanitization to prevent sensitive data from being leaked with debug data sent to the untrusted entity 602.

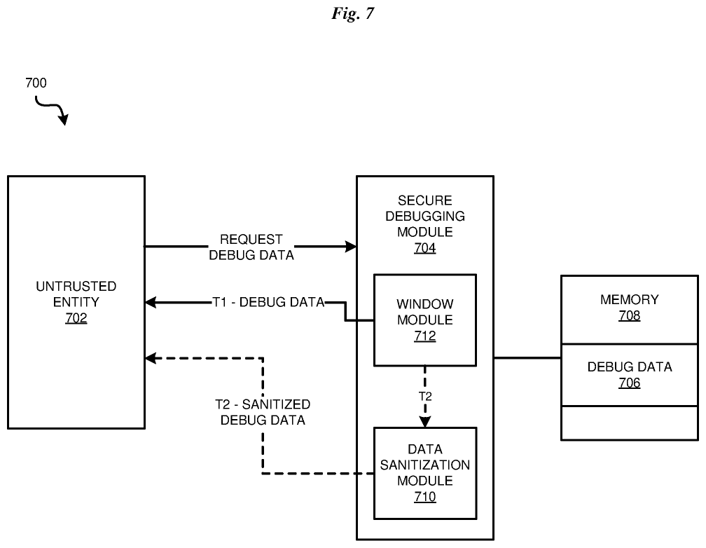

With reference to FIG. 7, this figure depicts a functional block diagram of a data protection process 700 in accordance with an illustrative embodiment. In the illustrated embodiment, a secure debugging module 704 is an example of the secure debugging module 200 of FIGS. 1-2 or the secure debugging module 300 of FIG. 3. Also, in the illustrated embodiment, the secure debugging module 704 performs the data protection process 700, whereas in alternative embodiments, some or all of the data protection process 700 may be performed by one or more alternative devices or modules.

In the illustrated embodiment, the memory 708 is protected memory. The untrusted entity 702 may be a debugging device that is not part of the chain of trust of the host system for the secure debugging module 704 and the memory 708. Thus, the untrusted entity 702 is not authorized to directly access the debug data 706 in the protected memory 708. Instead, the untrusted entity 702 must request the debug data from the secure debugging module 704.

In the illustrated embodiment, the secure debugging module 704 receives the request for debug data 706. Responsive to the request, the secure debugging module 704 uses a data sanitization module 710 to analyze the debug data using a sensitive data detection/sanitization process that detects and removes sensitive data in the debug data. In some embodiments, the data sanitization module 710 may be part of a kernel (e.g., kernel 208 of FIG. 2).

In the illustrated embodiment, the window module 712 detects whether sensitive data was being processed during a window of time in which the system error occurred, for example by reviewing system logs. For example, in some embodiments, the window module 712 reviews the system logs using an audit policy that includes a set of preferences, rules and/or criteria that the window module 712 uses to identify sensitive data in the debug data 706. For example, an audit policy may define “sensitive objects” as files or objects that contain particular keywords (e.g., “confidential,” or “privileged”) and/or are associated with particular keywords (e.g., in metadata) or particular flags (e.g., in metadata identifying a document or email as personal, confidential, etc.). An audit policy may further specify rules for handling sensitive objects. As an example, an audit policy may require that a reviewer approve the transfer of any potentially sensitive objects from the protected memory to the untrusted entity 702.

In the illustrated embodiment, two examples of time windows are referenced as T1 and T2, respectively. For the first example, during a time window T1, no sensitive data was being processed. Therefore, for the T1 example, the debug data 706 can be sent to the untrusted entity 702. For the second example, during a time window T2, sensitive data was being processed. Therefore, for the T2 example, the data sanitization module 710 sanitizes the debug data by removing the sensitive data before sending the debug data to the untrusted entity 702. Alternatively, for the example T2, the debug data may be withheld completely from the untrusted entity 702 due to the presence of sensitive content in the debug data.

Thus, in some embodiments, the data protection process includes one or more protective measures in the form of a time-window analysis to prevent sensitive data from being leaked with debug data sent to the untrusted entity 702.

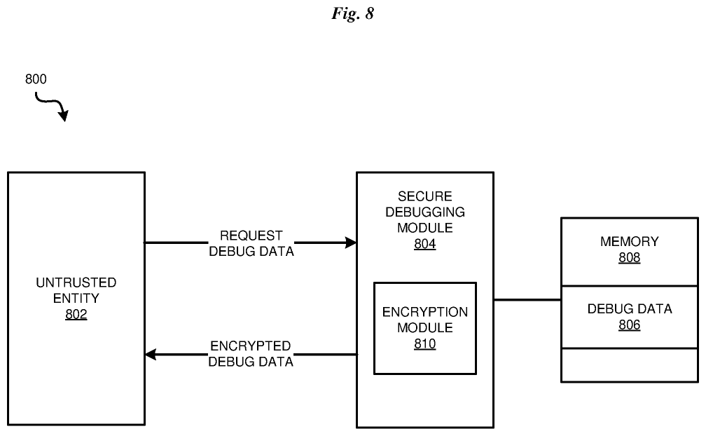

With reference to FIG. 8, this figure depicts a functional block diagram of a data protection process 800 in accordance with an illustrative embodiment. In the illustrated embodiment, a secure debugging module 804 is an example of the secure debugging module 200 of FIGS. 1-2 or the secure debugging module 300 of FIG. 3. Also, in the illustrated embodiment, the secure debugging module 804 performs the data protection process 800, whereas in alternative embodiments, some or all of the data protection process 800 may be performed by one or more alternative devices or modules.

In the illustrated embodiment, the memory 808 is protected memory. The untrusted entity 802 may be a debugging device that is not part of the chain of trust of the host system for the secure debugging module 804 and the memory 808. Thus, the untrusted entity 802 is not authorized to directly access the debug data 806 in the protected memory 808. Instead, the untrusted entity 802 must request the debug data from the secure debugging module 804.

In the illustrated embodiment, the secure debugging module 804 receives the request for debug data. Responsive to the request, the secure debugging module 804 uses an encryption module 810 to encrypt the debug data 806 before sending the debug data to the untrusted entity 802. In some embodiments, the encryption module 810 first checks the debug data for sensitive data and then only encrypts the debug data 806 if it contains sensitive data. In some such embodiments, the encryption module 810 only encrypts the sensitive data in the debug data.

In some embodiments, the data sanitization module 810 detects sensitive data according to an audit policy. An audit policy is a set of preferences, rules and/or criteria that protect sensitive data in the debug data. For example, an audit policy may define “sensitive objects” as files or objects that contain particular keywords (e.g., “confidential,” or “privileged”) and/or are associated with particular keywords (e.g., in metadata) or particular flags (e.g., in metadata identifying a document or email as personal, confidential, etc.). An audit policy may further specify rules for handling sensitive objects. As an example, an audit policy may require that a reviewer approve the transfer of any potentially sensitive objects from the protected memory to the untrusted entity 802.

Thus, in some embodiments, the data protection process includes one or more protective measures in the form of data encryption to prevent sensitive data from being leaked with debug data sent to the untrusted entity 802.

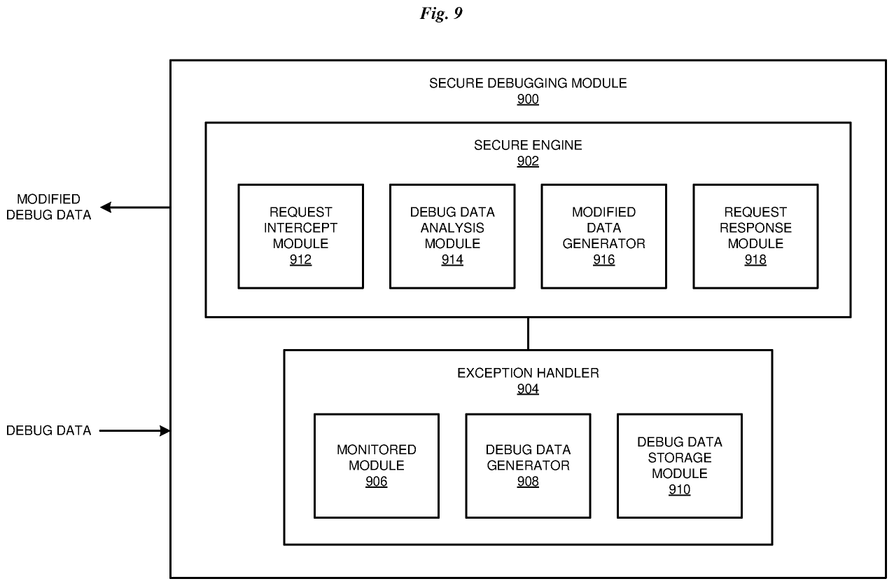

With reference to FIG. 9, this figure depicts a block diagram of an example secure debugging module 900 in accordance with an illustrative embodiment. In a particular embodiment, the secure debugging module 900 is a more detailed example of the secure debugging module 200 of FIGS. 1 and 2 or the secure debugging module 300 of FIG. 3.

In the illustrated embodiment, the secure debugging module 900 includes secure engine 902 and an exception handler 904. In some embodiments, the secure engine 902 is an example of the secure engine 318 of FIG. 3 and the exception handler 904 is an example of the exception handler 316 of FIG. 3.

In the illustrated embodiment, the secure engine 902 includes a request intercept module 912, debug data analysis module 914, modified data generator 916, and a request response module 918. The exception handler 904 includes a monitoring module 906, debug data generator 908, a debug data storage module 910. In alternative embodiments, the secure debugging module 900 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the monitoring module 906 monitors (e.g., using an exception handler) status data indicative of an operational state of a processor-based system. In some embodiments, the monitoring comprises identifying status data associated with a system error that satisfies a reboot condition. In some such embodiments, the system schedules a reboot event responsive to satisfaction of the reboot condition. In some embodiments, the system error is associated with a kernel error involving a halt to at least a portion of a kernel operating on the system; wherein the reboot event comprises a warm reboot that does not initialize the memory.

In the illustrated embodiment, the debug data generator 908 generates debug data indicative of a state of the system as the system error occurred. In some embodiments, the generated debug data comprises a copy of data extracted from a processor memory (e.g., register and/or cache).

In the illustrated embodiment, the debug data storage module 910 stores the debug data in a memory that retains data during the reboot event. In the illustrated embodiment, the request intercept module 912 intercepts a debug data request from an untrusted entity, thereby preventing the untrusted entity from directly accessing the debug data in the memory. In the illustrated embodiment, the debug data analysis module 914 analyzes the debug data using a sensitive data detection process to detect sensitive data in the debug data.

In the illustrated embodiment, the modified data generator 916 generates modified debug data by performing a data protection process on the debug data. In some such embodiments, the modified data generator 916 performs a protective measure against a leak of the sensitive data. In some such embodiments, the protective measure comprises sanitizing the debug data by removing the sensitive data from the debug data. In some embodiments, the protective measure comprises detecting whether sensitive data was being processed during a window of time in which the system error occurred. In some such embodiments, if the modified data generator 916 detects that sensitive data was being processed during the window of time, sanitizing the debug data by removing the sensitive data from the debug data before sending it to the untrusted entity. In some embodiments, the protective measure comprises encrypting sensitive data in the debug data.

In the illustrated embodiment, the request response module 918 sends, as a response to the debug data request, the modified debug data to the untrusted entity. In some such embodiments, the request response module 918 sends of the modified debug data using a trusted protocol.

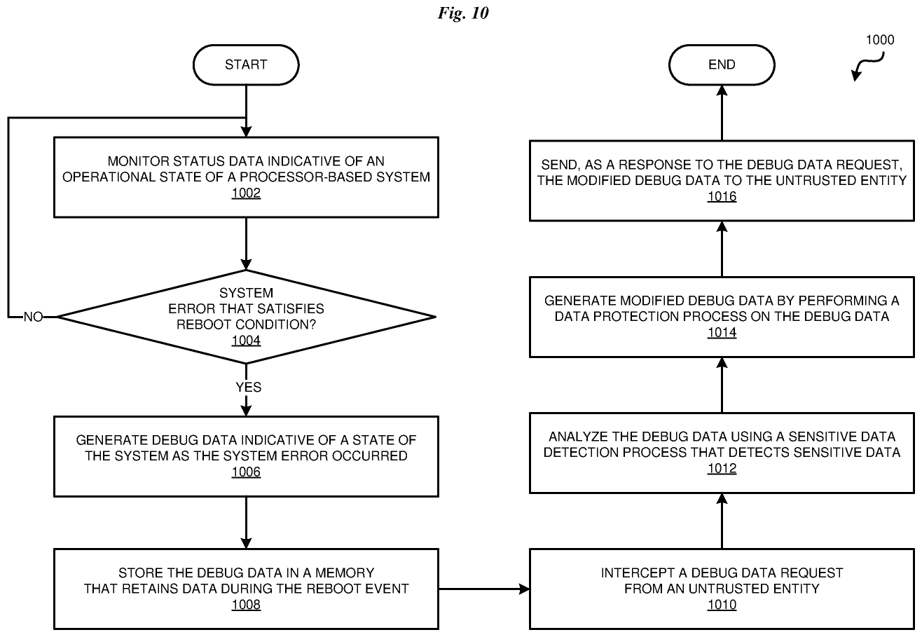

With reference to FIG. 10, this this figure depicts a flowchart of an example process 1000 for securing sensitive debug data in accordance with an illustrative embodiment. In a particular embodiment, the secure debugging module 200 of FIG. 2 carries out the process 1000.

In the illustrated embodiment, at block 1002 the process monitors (e.g., using an exception handler) status data indicative of an operational state of a processor-based system. In some embodiments, the monitoring comprises identifying status data associated with a system error. At block 1004, the process determines whether the system error necessitates a reboot to recover (i.e., satisfies a reboot condition). For example, in some embodiments, an example of a system error that requires a reboot and therefore satisfies a reboot condition is any system error involving a halt to at least a portion of a kernel operating on the system. In some such embodiments, the system schedules a reboot event upon the condition for rebooting being satisfied.

In the illustrated embodiment, at block 1006 the process generates debug data indicative of a state of the system as the system error occurred. In some embodiments, the generated debug data comprises a copy of data extracted from a processor memory (e.g., register and/or cache).

In the illustrated embodiment, at block 1008 the process stores the debug data in a memory that retains data during the reboot event. In the illustrated embodiment, at block 1010 the process intercepts a debug data request from an untrusted entity, thereby preventing the untrusted entity from directly accessing the debug data in the memory. In the illustrated embodiment, at block 1012 the process analyzes the debug data using a sensitive data detection process to detect sensitive data in the debug data.

In the illustrated embodiment, at block 1014 the process generates modified debug data by performing a data protection process on the debug data. In some such embodiments, the process performs a protective measure against a leak of the sensitive data. In some such embodiments, the protective measure comprises sanitizing the debug data by removing the sensitive data from the debug data. In some embodiments, the protective measure comprises detecting whether sensitive data was being processed during a window of time in which the system error occurred. In some such embodiments, if the process detects that sensitive data was being processed during the window of time, sanitizing the debug data by removing the sensitive data from the debug data before sending it to the untrusted entity. In some embodiments, the protective measure comprises encrypting sensitive data in the debug data.

In the illustrated embodiment, at block 1016 the process sends, as a response to the debug data request, the modified debug data to the untrusted entity. In some such embodiments, the request response module 918 sends of the modified debug data using a trusted protocol.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
monitoring, by an exception handler, an operational state of a processor-based system, wherein the monitoring comprises identifying a system error that satisfies a reboot condition, wherein the system schedules a reboot event responsive to satisfaction of the reboot condition;
generating debug data indicative of the operational state when the system error occurred;
storing the debug data in a memory that retains data during the reboot event;
intercepting a debug data request from an untrusted entity, thereby preventing the untrusted entity from directly accessing the debug data in the memory;
analyzing the debug data using a sensitive data detection process, wherein the analyzing detects sensitive data in the debug data;
generating modified debug data by performing a data protection process on the debug data; and
sending, as a response to the debug data request, the modified debug data to the untrusted entity.

2. The method of claim 1, wherein the system error is associated with a kernel error involving a halt to at least a portion of a kernel operating on the system.

3. The method of claim 1, wherein the debug data comprises data extracted from a processor register.

4. The method of claim 1, wherein the reboot event comprises a warm reboot that does not initialize the memory.

5. The method of claim 1, wherein the data protection process comprises performing a protective measure against a leak of the sensitive data.

6. The method of claim 5, wherein protective measure comprises sanitizing the debug data by removing the sensitive data from the debug data.

7. The method of claim 5, wherein the protective measure comprises detecting whether sensitive data was being processed during a window of time in which the system error occurred.

8. The method of claim 7, wherein the protective measure further comprises, responsive to detecting that sensitive data was being processed during the window of time, sanitizing the debug data by removing the sensitive data from the debug data.

9. The method of claim 5, wherein the protective measure comprises encrypting sensitive data in the debug data.

10. The method of claim 1, wherein the sending of the modified debug data comprises sending the modified debug data using a trusted protocol.

11. A computer program product comprising one or more computer readable storage media, and program instructions collectively stored on the one or more computer readable storage media, the program instructions executable by a processor to cause the processor to perform operations comprising:
monitoring, by an exception handler, an operational state of a processor-based system, wherein the monitoring comprises identifying a system error that satisfies a reboot condition, wherein the system schedules a reboot event responsive to satisfaction of the reboot condition;
generating debug data indicative of the operational state when the system error occurred;
storing the debug data in a memory that retains data during the reboot event;
intercepting a debug data request from an untrusted entity, thereby preventing the untrusted entity from directly accessing the debug data in the memory;
analyzing the debug data using a sensitive data detection process, wherein the analyzing detects sensitive data in the debug data;
generating modified debug data by performing a data protection process on the debug data; and
sending, as a response to the debug data request, the modified debug data to the untrusted entity.

12. The computer program product of claim 11, wherein the stored program instructions are stored in a computer readable storage device in a data processing system, and wherein the stored program instructions are transferred over a network from a remote data processing system.

13. The computer program product of claim 11, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

14. The computer program product of claim 11, wherein the data protection process comprises performing a protective measure against a leak of the sensitive data,
wherein protective measure comprises sanitizing the debug data by removing the sensitive data from the debug data.

15. The computer program product of claim 11, wherein the data protection process comprises performing a protective measure against a leak of the sensitive data,
wherein the protective measure comprises detecting whether sensitive data was being processed during a window of time in which the system error occurred.

16. The computer program product of claim 11, wherein the data protection process comprises performing a protective measure against a leak of the sensitive data,
wherein the protective measure comprises encrypting sensitive data in the debug data.

17. A computer system comprising a processor and one or more computer readable storage media, and program instructions collectively stored on the one or more computer readable storage media, the program instructions executable by the processor to cause the processor to perform operations comprising:
monitoring, by an exception handler, an operational state of a processor-based system, wherein the monitoring comprises identifying a system error that satisfies a reboot condition, wherein the system schedules a reboot event responsive to satisfaction of the reboot condition;
generating debug data indicative of the operational state when the system error occurred;
storing the debug data in a memory that retains data during the reboot event;
intercepting a debug data request from an untrusted entity, thereby preventing the untrusted entity from directly accessing the debug data in the memory;
analyzing the debug data using a sensitive data detection process, wherein the analyzing detects sensitive data in the debug data;
generating modified debug data by performing a data protection process on the debug data; and
sending, as a response to the debug data request, the modified debug data to the untrusted entity.

18. The computer system of claim 17, wherein the data protection process comprises performing a protective measure against a leak of the sensitive data,
wherein protective measure comprises sanitizing the debug data by removing the sensitive data from the debug data.

19. The computer system of claim 17, wherein the data protection process comprises performing a protective measure against a leak of the sensitive data,
wherein the protective measure comprises detecting whether sensitive data was being processed during a window of time in which the system error occurred.

20. The computer system of claim 17, wherein the data protection process comprises performing a protective measure against a leak of the sensitive data,
wherein the protective measure comprises encrypting sensitive data in the debug data.
